(19) United States
(12) Patent Application Publication
(10) Pub. No.: US 2005/0232560 A1
(43) Pub. Date: Oct. 20, 2005

(54) METHOD AND APPARATUS RELATING TO OPTICAL FIBRE WAVEGUIDES

(75) Inventors: Jonathan Cave Knight, Wellow (GB); Philip St. John Russell, Bath (GB); Timothy Adam Birks, Bath (GB); Brian Joseph Mangan, Bath (GB)

Correspondence Address: FOGG AND ASSOCIATES, LLC, P.O. BOX 581339, MINNEAPOLIS, MN, 55458-1339, US

(73) Assignee: BLAZEPHOTONICS LIMITED, AVON (GB)

(21) Appl. No.: 10/498,414

(22) PCT Filed: Dec. 5, 2002
(86) PCT No.: PCT/GB02/05461

§ 371 Date: Jun. 10, 2005

(30) Foreign Application Priority Data
Dec. 11, 2001 (GB) 01296383

(51) Int. Cl. G02B 6/20

(52) U.S. Cl. 385/125

(57) ABSTRACT

An optical fibre comprises: (i) a plurality of elongate, tubular, higher-refractive-index regions (20,50) of dielectric material, the regions being concentric about a longitudinal axis; (ii) a plurality of elongate, tubular lower-refractive-index regions, arranged between the higher-index regions (20,50), and comprising bridging regions (30), of a solid dielectric material, and a plurality of elongate holes (40); and (iii) a core region (10). The higher-index regions (20,50) and the lower-index regions (40) together define a cladding structure arranged to guide light in the core region (10). The elongate holes (40) are arcuate in cross-section.

This invention relates to the field of optical fibre waveguide.

Single-mode and multimode optical fibres are widely used in applications such as telecommunications. The fibres are typically made entirely from solid materials such as glass, and each fibre typically has the same cross-sectional structure along its length. Transparent material in one part (usually the middle) of the cross-section has a higher refractive index than material in the rest of the cross-section and forms an optical core within which light is guided by total internal reflection. We refer to such a fibre as a conventional fibre or a standard fibre.

Most standard fibres are made from fused silica glass, incorporating a controlled concentration of dopant, and have a circular outer boundary typically of diameter 125 microns. Standard fibres may be single-mode or multimode. Particular standard fibres may have particular properties, such as having more than one core or being polarisation-maintaining or dispersion compensating.

In the past few years, non-standard types of optical fibre waveguide have been demonstrated.

One type of non-standard fibre is based on Bragg reflection. Bragg reflections are well known in the art. Reflections from a number of periodically arrayed interfaces combine to form an overall higher reflection, which can be 100%. The combined “Bragg stack” gives rise to a greater reflection than that obtained from a single layer because of the fixed phase relationship between the reflections from the individual layers. Bragg waveguides use such Bragg reflections to trap light in a waveguiding core. Such waveguides can be made in the form of a fibre using a low-index-contrast circular Bragg stack, which can be fabricated using modified chemical vapour deposition (MCVD) (see Marcou et al, Electron. Lett. Vol. 36 No. 6 p514 (2000)). However, there is no evidence that such a fibre structure can support low-loss modes in an air hole.

An example of a Bragg-reflector optical fibre is based on the dielectric omnidirectional reflector described in Y. Fink et al, Science 282, 1679 (1998) and Y. Fink et al, J. Lightwave Tech 17, 2039 (1999). (The possibility of such reflectors was discussed in P. Yeh, A. Yariv, E. Marom, J. Opt. Soc. Am. 68, 1196 (1978).) Fink's reflector is a dielectric stack, having alternate layers of lower and higher refractive index and is designed so that it reflects light that is incident from any angle.

Another example of a waveguide incorporating a Bragg-reflector dielectric stack is the co-axial omni-guide, described in International Patent Application No. WO 00/65386 and by M. Ibanescu et al, in Science, vol. 289, p. 415-419, 21 Jul. 2001. That waveguide is an all-dielectric coaxial waveguide comprising an annular waveguiding region with a low refractive index bounded by two dielectric, omnidirectionally reflecting mirrors. One of the mirrors, which may be a single, dielectric material or a multilayer dielectric material, forms a cylindrical central region and the other mirror, which comprises a multilayer dielectric material, forms a tubular region coaxial with and surrounding the central region and the annular waveguiding region. The transverse electromagnetic mode supported by the waveguide is said to be very similar to the transverse electromagnetic mode of a traditional metallic coaxial cable.

Thus, in all of the structures known to date that guide light by providing Bragg stacks in the form of concentric shells, the Bragg stack is composed of alternating layers of solid dielectric materials.

European Patent Application No. 98307020.2 (published as EP 905 834) describes an optical fibre having a core and inner cladding, which guide light by total internal reflection, and a first outer cladding region that contains a plurality of holes. The first outer cladding is provided to optically isolate the inner cladding and the core.

Jianqui Xu et al, Opt. Comm., 182, 343-348 (2000) teach a fibre that has a cylindrically symmetrical arrangement of holes in a cladding region and a high-index core. In the penultimate paragraph of that paper such a structure having a cylindrically symmetrical arrangement of holes in a cladding region but a low-index core is compared with photonic-crystal fibres that have a low-index core and exhibit photonic band-gap guidance. It is observed that ‘because there is no periodic structure in the cladding [of the former structure], there is no guided mode in the centre . . . in contrast photonic-crystal cladding hollow fibre, which has the cladding consisting of honeycomb arranging holes and the low index core, trap the electromagnetic field by photonic band-gap effects’.

Guidance in fibres having cladding including holes has also been achieved by using the concept of a photonic crystal (a 2- or 3-dimensionally periodic structure—that is, a lattice-like structure—with a relatively high index contrast). Using this concept, optical fibres have been formed in which light is guided in an air core. Such 2- or 3-dimensionally periodic structures can readily be formed by stacking an array of glass rods and/or tubes.

An example type of such fibres is called (equivalently) a photonic-crystal fibre (PCF), a holey fibre or a microstructured fibre [J. C. Knight et al., Optics Letters v. 21 p. 203], and is typically made from a single solid material such as fused silica glass, within which is embedded a plurality of elongate air holes. The holes run parallel to the fibre axis and extend the full length of the fibre.

In one type of such a fibre a region of solid material between holes, larger than neighbouring such regions, can act as a waveguiding fibre core. Light can be guided in the core in a manner analogous to total-internal-reflection guiding in standard fibres. The array of holes need not be periodic for total-internal-reflection guiding to take place (one may nevertheless refer to such a fibre as a photonic-crystal fibre). However, total-internal-reflection guiding in an air core is not possible, as the core must have a higher refractive index than the cladding.

However, there is another mechanism for guiding light in a photonic-crystal fibre, which is based on photonic-bandgap effects rather than total internal reflection. For example, light can be confined inside a hollow core (an enlarged air hole) by a suitably-designed array of smaller holes surrounding the core [R. F. Cregan et al., Science v. 285 p. 1537]. True guidance in a hollow core is not possible at all in standard fibres.

Photonic-crystal fibres can be fabricated by stacking glass elements (rods and tubes) on a macroscopic scale into the required pattern and shape. This primary preform can then be drawn into a fibre, using the same type of fibre-drawing tower that is used to draw standard fibre from a standard-fibre preform. The primary preform can, for example, be formed from fused silica elements with a diameter of about 0.8 mm.

International Patent Application No. PCT/JP01/03805, published as WO 01/88578, teaches an optical fibre having a core region and a cladding region which surrounds the core region. A plurality of regions made of sub mediums, having refractive index different from that of the main medium constituting the cladding region, are spaced apart in cross section of the cladding region. The mean refractive index of the core region is lower than that of the cladding region. The sub-medium regions are regularly arranged in the radial direction of the optical fibre such that the light having given wavelength, propagation coefficient and electric field distribution propagates along the fibre axis and has not less than 50% of a total propagating power in the core region. This arrangement does not have translational symmetry in cross section.

International Patent Application No. PCT/DK01/00774, published (after the priority date of the present application) as WO 02/41050, teaches a microstructured fibre having a cladding comprising a number of elongated features that are arranged to provide concentric circular or polygonal regions surrounding the fibre core. The cladding comprises a plurality of concentric cladding regions, at least some of which comprising cladding features. Cladding regions comprising cladding features of a relatively low index type are arranged alternatingly with cladding regions of a relatively high index type. The cladding features are arranged in a non-periodic manner when viewed in a cross section of the fibre. The cladding enables waveguidance by photonic bandgap effects in the fibre core. The document states that an optical fibre of this type may be used for light guidance in hollow core fibres for high power transmission and that the special cladding structure may also provide strong positive or negative dispersion of light guided through the fibre, making the fibre useful for telecommunication applications.

An object of the invention is to provide an improved hollow-core waveguide and a method of manufacturing such a waveguide.

According to the invention there is provided an optical fibre comprising: (i) a plurality of tubular, higher-refractive-index regions of dielectric material, the higher-index regions being elongate along and concentric about a longitudinal axis; (ii) a plurality of tubular lower-refractive-index regions, arranged between the higher-index regions, the lower-index regions being elongate along the longitudinal axis and comprising bridging regions, of a solid dielectric material, and a plurality of holes, the holes being elongate along the longitudinal axis; and (iii) a core region; wherein the higher-index regions and the lower-index regions together define a cladding structure arranged to guide light in the core region; characterised in that the elongate holes are, in addition to being elongate along the longitudinal axis, elongate in cross-section. The core and the concentric tubular regions around it may form part of a larger fibre structure, with which they are not concentric. For example, the core and the tubular regions may be eccentrically placed within the fibre as a whole. As another example, the fibre as a whole may include more than one core, each with its own set of concentric tubular regions, at least one such core not being at the centre of the fibre as a whole. Unlike the case of a fibre that guides by total-internal-reflection, the core region may have a low refractive index. It may be formed of a solid material, a liquid or a gas.

Preferably, the core region comprises a hole that is elongate along the longitudinal axis of the fibre. Preferably, the core region consists of an elongate hole. The hole will typically be of a diameter of between about a micron and several tens of microns.

Preferably, the cladding structure is periodic.

The higher-refractive-index regions may be of a solid dielectric material.

Thus a fibre is provided by the invention that has, in its cross-section in a plane perpendicular to the longitudinal axis of the fibre, a cladding region comprising a radial, dielectric stack-like structure that has a high index-contrast between its regions of higher and lower refractive index, the high index-contrast resulting from the inclusion of air holes (which have a very low refractive index) in the lower-index regions. A high index-contrast is advantageous because it provides strong confinement of light to the core region. The shells of the stack are thus provided by alternating regions of solid dielectric regions and regions containing holes. Preferably, the shells are of a thickness between about a micron and about ten microns.

Alternatively, the higher-index regions may themselves contain a plurality of holes.

Various parameters of the cladding can be adjusted to provide guidance of light of wavelength λ. Those parameters include, in particular, the period of the structure (that is, the widths of the higher-index and lower-index regions). The widths of the higher-index and lower-index regions need not be equal and need not be constant in all radial directions. In some embodiments, the widths of the lower-index and higher-index regions may be arranged so that the lower-index regions coincide with the zeros of a Bessel function.

If the regions are circular (that is, if the tubes are cylinders having a circular cross-section) then light can be confined in the core provided that the cladding structure has sufficient radial periodicity, a sufficient refractive-index contrast between the higher index regions and the lower index regions, and a symmetry sufficiently near to circular symmetry.

However, we have discovered that it is not necessary that the regions are circular for guiding in the core to be possible. Typically, such a non-circular structure is like an effective Bragg stack in any selected radial direction. However, the period differs depending on the selected direction and that makes it quite distinct from the circularly symmetric case. In general, the non-circular case will only be a waveguide if the index contrast is high enough to accommodate the different pitches in different directions; the index contrast therefore needs to be substantially higher than in the circularly symmetric case. Thus, in a non-circular structure (that is, a structure in which the tubes are cylindrical having a non-circular cross-section) light can be confined in the core provided there is a sufficiently high refractive index contrast between the high- and low-index layers and provided that they are sufficiently regular (in a radial direction). The required refractive index contrast will depend on the cross-sectional shape chosen; the refractive index of the lower-index regions may be varied from close to 1 to close to the refractive index of the bridging regions by changing the size of the holes in the tubular lower-refractive-index regions. The relative sizes of the holes and the dielectric material defining the holes affect the effective refractive index of the lower-index regions. (The effective refractive index is between the refractive index of the holes (that is, 1) and the refractive index of the dielectric material. Calculation of an accurate value must take into account the shape of the mode of light being guided in the fibre, in a manner known in the art.

Such a non-circularly symmetric structure may readily be fabricated from a bundle of rods and small-diameter tubes, such as those used to make photonic crystal fibres, as will be described hereinafter.

Two examples of non-circularly-symmetric structures comprise either concentric hexagonal or concentric elliptical tubes of higher-index material. A structure comprising elliptical tubes is one example of a structure that exhibits two-fold rotationally symmetry, which produces birefringence effects.

The elongate holes in the lower-index regions may be large relative to the solid dielectric material in those regions. For example, the holes may be substantially rectangular or arcuate; having a minor dimension in the radial direction and a major dimension that extends azimuthally about the centre of the core. In either case, the holes subtend an angle about the centre of the core, which is significantly greater than the angle subtended by the bridges of solid dielectric material. Additionally, the angle subtended by the holes may be smaller for outer, lower index regions compared with inner, lower index regions. For example, the number of holes in the lower index regions may increase with increasing radius of lower index region.

Preferably, for a structure having circular tubes, the number of holes N in each low index region is given by the equation:

$$N = Integer ( \frac{2 π r}{( nW + t )} ) \qquad ( Equation 1 )$$

where r is the radius of the low index region, measured as the average radius of the inner and outer edges of the layer, n is a number greater than 1, W is the radial thickness of the region, or the distance between the high index regions either side of the lower index region, and t is the thickness, at the narrowest point, of the bridges between the holes. As before, the holes in the lower-index regions are large relative to the solid dielectric material in those regions. In other words, according to Equation 1, t is significantly smaller than W; for example, at least five times smaller, or ten, fifteen or twenty times, or more, smaller. Expressed in another way, the bridging regions are preferably narrower than a wavelength of light to be guided in the fibre. For example, the bridging regions may be around half a wavelength, a third of a wavelength, or a quarter of a wavelength wide, or less. The bridging regions may, for example, be narrower than 1.0 microns, 0.5 microns, 0.2 microns or even 0.1 micron.

It will be appreciated that, for structures described by Equation 1, as n increases, the number of holes in a respective lower index region decreases. For example, if n=2, the holes have an approximate length that is twice their width (ignoring the width of the bridges); if n=3, the holes have an approximate length that is three times their width; etc. The value of n may be an integer number having a value, for example 2, 3, 4, 5, 6, 7, 8, 9, 10, 20, 50, 100 or higher.

Following on from above, each hole (and one neighbouring bridge) preferably subtends an angle θ (in radians) about the centre of the core according to the equation:

$$θ = \frac{2 π}{( N )} \qquad ( Equation 2 )$$

A larger refractive-index step between the higher-index and the lower-index layers provides better confinement of light to the core. The lower-index regions preferably have an effective refractive index that is very close to that of air, preferably a refractive index of less than 1.4. Still lower refractive indices may be preferable, for example refractive indices of less than 1.3, 1.2, 1.1, 1.05 or less than 1.01.

We have discovered that, subject to the following provision, in a structure with relatively large holes and relatively narrow bridges, the effective refractive index in the lower-index regions is dictated by the width of the bridges rather than by the spacing of the bridges (or, correspondingly, size of holes). This is true when the bridges are sufficiently spaced apart to avoid significant mode coupling between the bridges. With sufficient spacing between bridges, each bridge can be considered to be a slab waveguide, the fundamental mode of which determines the effective refractive index of the lower-index region. We have determined that spacing between bridges in the order of a small number of wavelengths of the light that is to propagate in the waveguide, for example, 1, 2, 3, 4, 5, or more wavelengths, is sufficient to reduce coupling to below an acceptable level to validate the foregoing slab waveguide analysis.

Of course, the holes may be of different sizes within each lower-index region; for example, they may be arranged in a pattern having two-fold rotational symmetry about the core of the fibre, to produce birefringence effects. The holes may be of different sizes in different lower-index regions; for example, a graded-index structure may be provided, in which the size of the holes decreases, and the width of the bridges increases, in each stack layer in an outward radial direction.

The size of the core is chosen to enable guiding of light. The appropriate size will be readily determined by a person skilled in the art.

Thus, this invention may provide fibres, having a low core refractive index, which are not lattice-like, 2-dimensionally periodic structures, but which can nonetheless be formed from glass. There are embodiments of the invention that are fibres consisting of a series of concentric rings (which could be circular or non-circular) of alternating high and low refractive index, which form a connected—and hence a rigid—structure. Such a structure can be fabricated from glass on a macroscopic scale—as a preform—and then drawn down to form a fibre with the correct structure and of the appropriate dimensions. Provided that there is a sufficiently high refractive index contrast between the two phases, guided modes can be formed even if the structure is not strictly circular. Preferably, the core region has a larger cross-sectional area, in the plane perpendicular to the longitudinal axis, than any of the holes in the lower-index regions. A larger core region may result in multimode operation for core sizes above a certain threshold size.

Preferably, the solid dielectric material in the higher-index regions and the solid dielectric material in the lower-index regions are the same material. More preferably, that material is silica.

Preferably, the higher-index regions are tubular regions of circular cross-section in the plane perpendicular to the longitudinal axis. Alternatively, the higher-index regions may be tubular regions of non-circular cross-section; for example, they may be tubes of hexagonal cross-section or elliptical cross section.

Also according to the invention there is provided a method of making an optical fibre, comprising:
(1) providing a plurality of solid dielectric canes or tubes and dielectric capillaries;
(2) bundling the canes or tubes and capillaries together to form a bundle having a plurality of concentric regions formed of the canes or tubes, such regions being separated from each other by regions comprising the capillaries;
(3) drawing the bundle into an optical fibre, in which the concentric regions formed of the canes or tubes form solid, tubular higher-index regions that are elongate along the longitudinal axis of the fibre, the regions comprising the capillaries form lower-index regions separating the higher-index regions, the lower-index regions being elongate along the longitudinal axis and comprising a plurality of bridging regions and a plurality of holes, the holes being elongate along the longitudinal axis, and a core region is formed, wherein, in the optical fibre, the higher-index regions and the lower-index regions together define a structure arranged to guide light in the core region; characterised in that the elongate holes are, in addition to being elongate along the longitudinal axis, formed to be elongate in cross-section.

Preferably, a hole in the bundle forms the core region.

The method may thus provide a simple method of manufacturing an optical fibre comprising a cladding region comprising a radial dielectric stack having lower-index layers including holes.

Preferably, the canes and capillaries are formed of the same dielectric material. More preferably, that material is silica.

Preferably, the canes and/or capillaries have a substantially circular outer cross-section. Preferably, the canes and/or capillaries have a diameter of the order of between a fraction of a millimetre and a few millimetres in diameter. Preferably, the canes and/or capillaries have a length of between several centimetres and a metre or more. Preferably, the canes and/or capillaries have substantially the same outer diameter. Preferably, the canes and capillaries are fused together. Preferably, the bundle is assembled and then drawn down in size to form a preform prior to drawing of the fibre.

Alternatively, a preform element may be formed by extrusion. Alternatively, a preform element may be formed by casting of sol-gel material.

Preferably, the bundle is enclosed in an outer jacket.

It may be that, in the bundle, the regions comprising the capillaries contain no canes. Alternatively, it may be that the regions comprising the capillaries contain canes interspersed amongst the capillaries.

Preferably the hole in the bundle that forms the core region is defined by a tube. Preferably, the tube has a central hole that is larger in cross-sectional area than the central hole in the capillaries. Alternatively, the tube itself may be a capillary. Preferably, the hole in the bundle that forms the core region is pressurised during the drawing of the fibre. Pressurisation results in the pressurised region diminishing in cross-section less than unpressurised regions during the drawing process.

Preferably, the plurality of concentric regions formed of the canes are arranged in rings in the bundle.

Alternatively, the plurality of concentric regions formed of the canes may be arranged in another pattern, such as a pattern not having circular symmetry; for example, they may be arranged as concentric hexagons.

Preferably, the capillaries are pressurised during the drawing of the fibre. Pressurisation of the capillaries that will form a lower-index region may result in very significant expansion of the capillary holes during drawing, such that in the resulting fibre the holes in the lower-index region are very much larger than the dielectric regions separating them, which had their origins in the outer material of the capillaries. Thus the method may provide a fibre in which the lower-index regions have an effective refractive index which is very close to that of air, preferably a refractive index of less than 1.1.

Preferably, the regions comprising the capillaries comprise a ring of capillaries, of which a plurality have thicker walls than the walls of the other capillaries in the ring, wherein the plurality of bridging regions are formed from the thicker-walled capillaries. Preferably, the thicker-walled capillaries are arranged in pairs and the method comprises the steps of fusing the bundle to form a preform and etching the preform to leave the bridging regions at sites where the capillaries of the pair abutted with each other. Preferably, the pairs of capillaries are arranged in different azimuthal positions in different lower-refractive-index tubular regions.

Also according to the invention there is provided a method of guiding light, the method comprising the step of propagating the light along a fibre described above as according to the invention. Also according to the invention there is provided use of a fibre described above as according to the invention to guide light.

Also according to the invention there is provided an optical system including an optical fibre as described above as being according to the invention. Examples of such optical systems are a telecommunications transmission system, a gas laser, a sensor and a non-linear switch.

Embodiments of the invention will now be described, by way of example only, with reference to the drawings, of which:

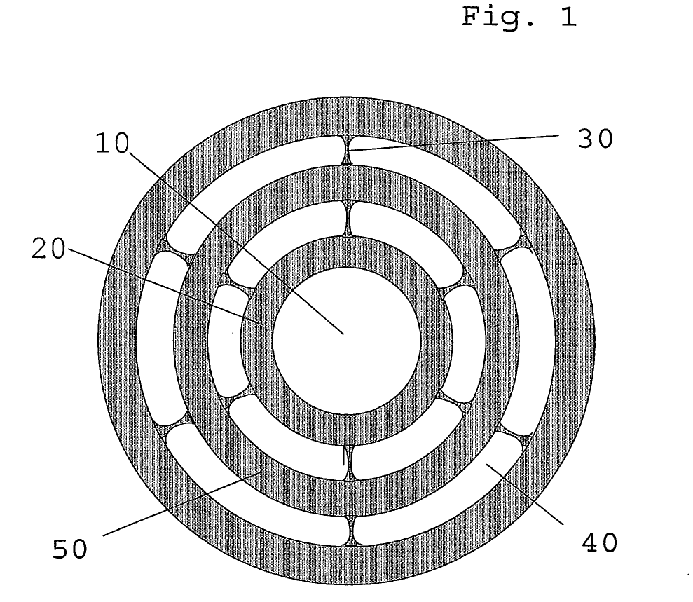

FIG. 1 is a cross-section of a first fibre waveguide according to an embodiment of the present invention.

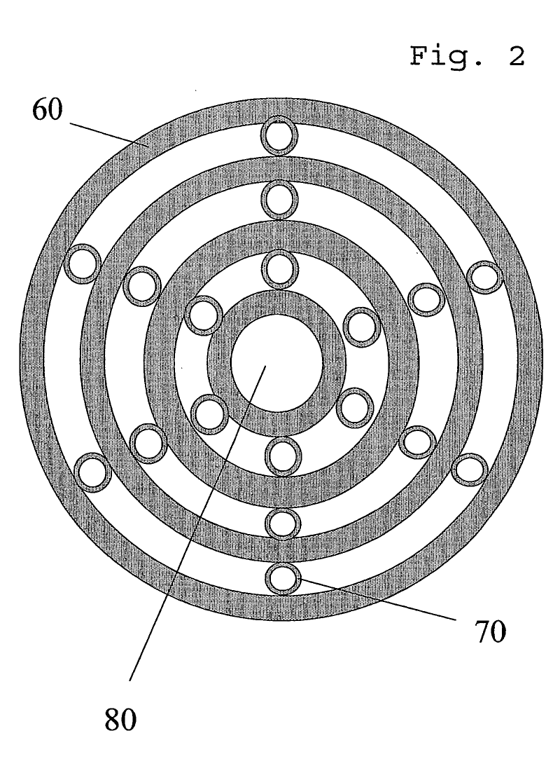

FIG. 2 is a cross-section of a fibre preform from which the fibre of FIG. 1 is drawn.

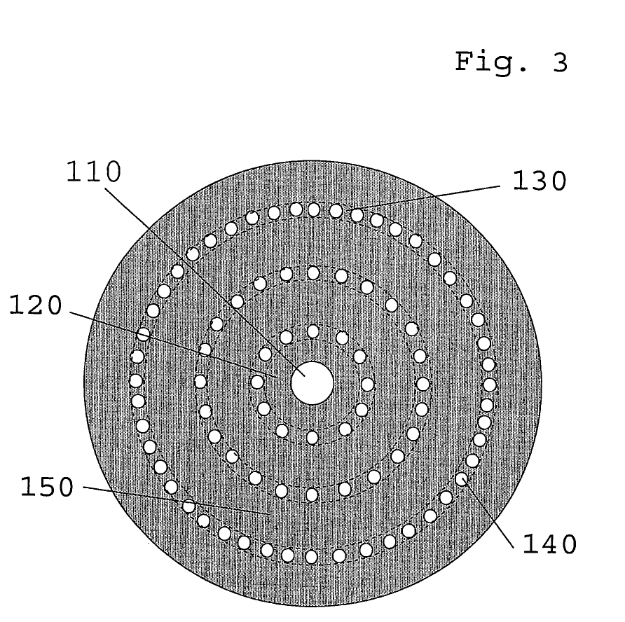

FIG. 3 is a cross-section of a second exemplary fibre waveguide.

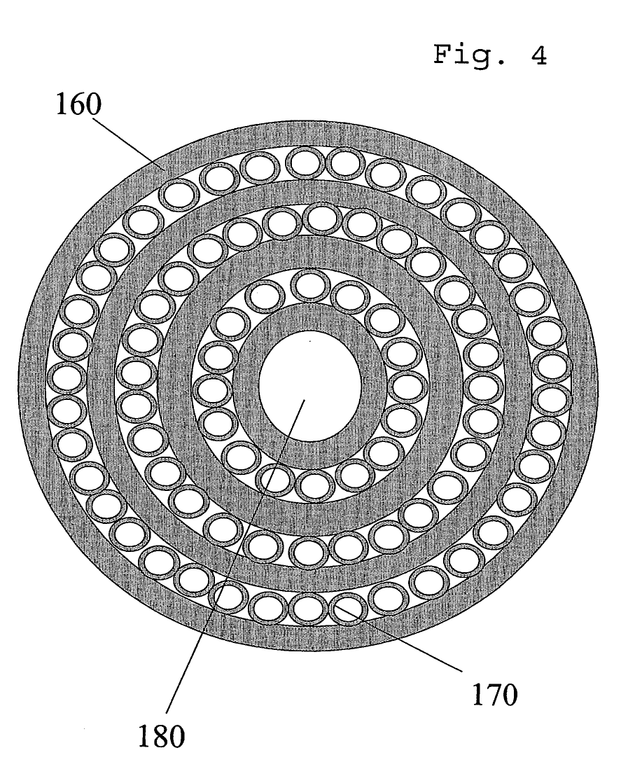

FIG. 4 is a cross-section of a fibre preform from which the fibre of FIG. 3 is drawn.

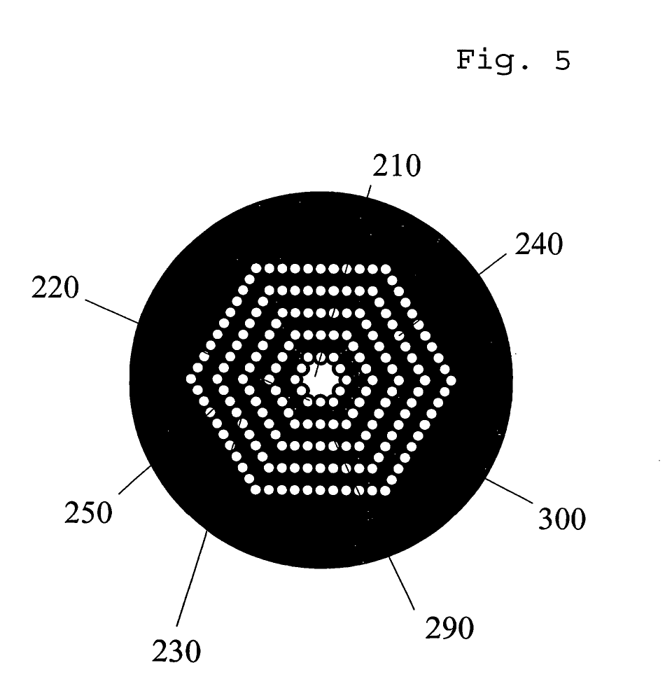

FIG. 5 is a cross-section of a third exemplary fibre waveguide.

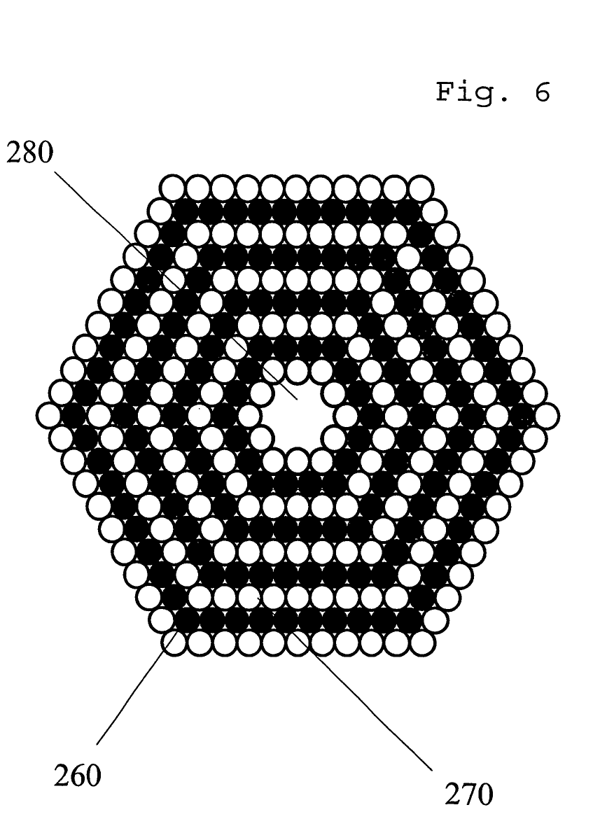

FIG. 6 is a cross-section of a fibre preform from which the fibre of FIG. 5 is drawn.

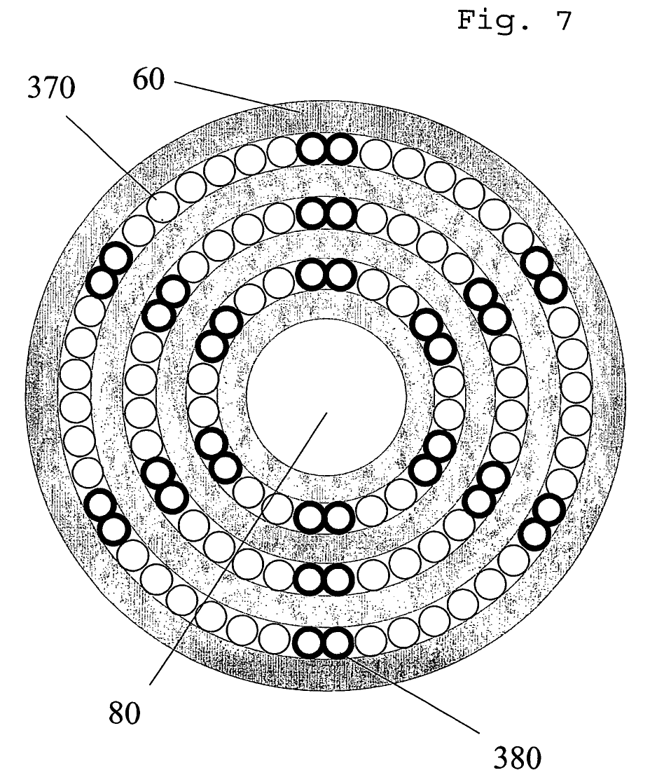

FIG. 7 is a cross-section of an alterative fibre preform from which the fibre of FIG. 1 may be drawn.

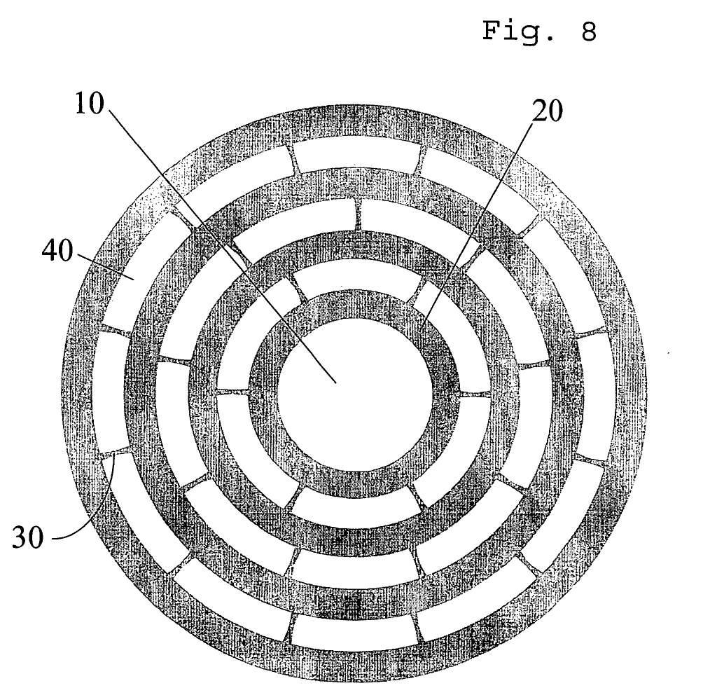

FIG. 8 is a cross section of a second fibre waveguide according to an embodiment of the present invention.

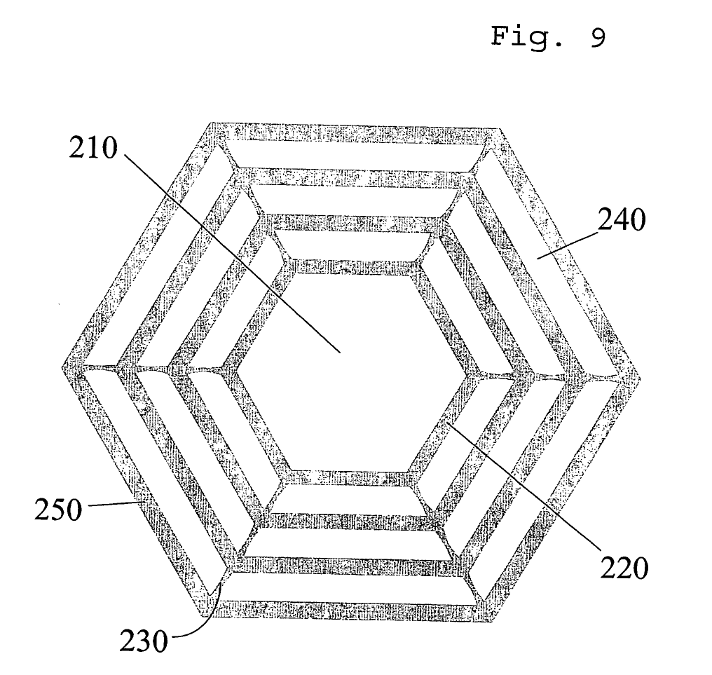

FIG. 9 is a cross section of a third fibre waveguide according to an embodiment of the present invention.

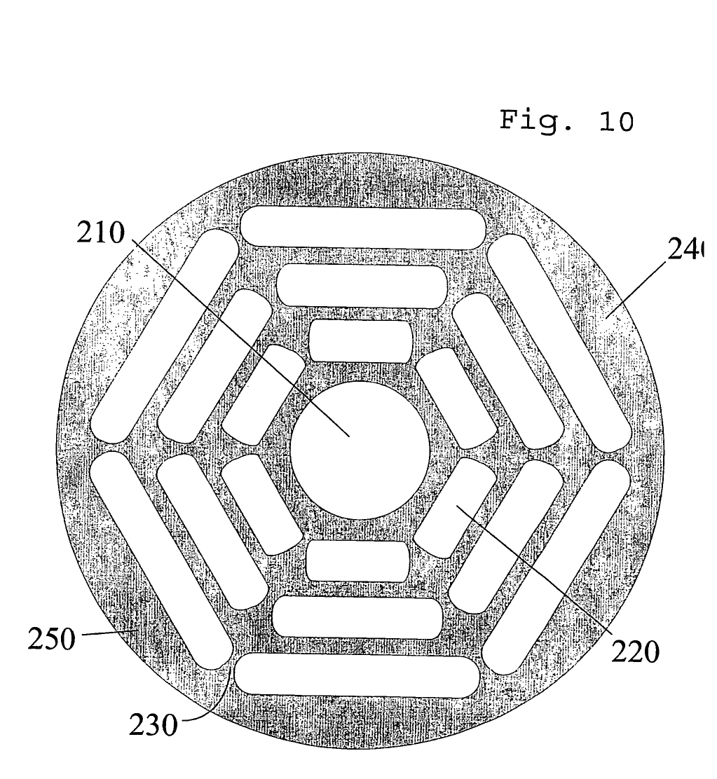

FIG. 10 is a cross section of a fourth fibre waveguide according to an embodiment of the present invention.

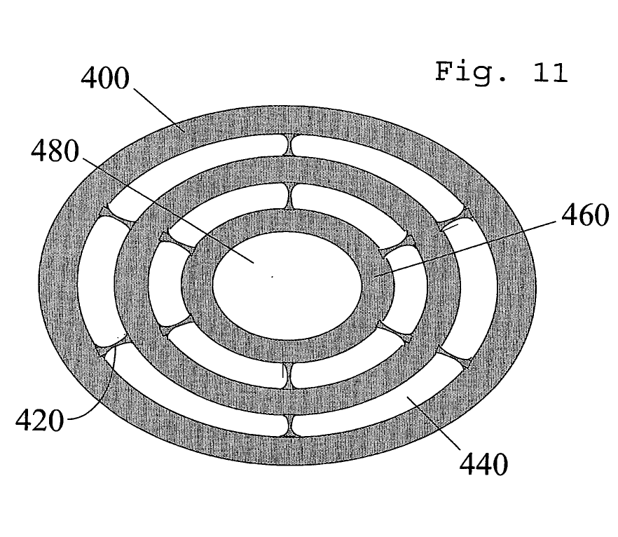

FIG. 11 is a cross section of a fifth fibre waveguide according to an embodiment of the present invention.

The fibres of FIGS. 1, 3, 5 and 8 to 11 are long, thin fibres similar to standard optical fibres. The preforms of FIGS. 2, 4, 6 and 7 are cylindrical; of course they are far less elongate than the fibre drawn from them.

The fibre waveguide of FIG. 1 comprises a plurality of elongate silica tubes 50, each of a thickness of the order of one micron. The tubes are annular in cross-section and form concentric shells. The innermost shell 20 defines an elongate, cylindrical core region 10, which is of circular cross-section. Core region 10 is a ‘hollow’ core; i.e., it is an air-filled region, in this example, it is of diameter about 10 microns. Tubes 20, 50 are kept apart from each other by silica bridges 30, which define air-filled regions 40. As can be seen from FIG. 1, the air-filled regions 40 are arcuate in cross-section.

Tubes 20, 50 and air-filled regions 40 together form a Bragg reflector in radial directions. Conceptually, the effect of bridges 30 is small, so the reflector can be regarded as being made from alternate layers of silica (refractive index 1.44) and air (refractive index 1). Such a structure provides a large refractive index step of Δn=0.44. Only two air-filled ring regions are shown in FIG. 1; in practice, it may be necessary to extend the Bragg structure to greater radii, although, as the large refractive-index step leads to strong confinement of light to the air core 10, it should not be necessary for there to be very many rings in the structure.

The fibre of FIG. 1 is manufactured in the following manner, from the preform of FIG. 2. A plurality of tubes 60 and further tubes that are thin-walled capillaries 70 are provided; each capillary 70 has a diameter of the order of 1 mm and a length of several tens of centimetres. A bundle is formed from the tubes 60 and capillaries 70 in which the tubes are arranged concentrically and are separated by concentric rings of capillaries 70. A hole 80 is formed at the centre of the bundle by the innermost of the tubes 60.

The tubes 60 and capillaries 70 in the bundle are fused to form a preform. The ends of the capillaries and the hole 80 are then sealed. The preform is then connected at both ends to a vacuum pump and unsealed spaces are evacuated. The fibre is then drawn from the preform on a fibre drawing rig, in a manner well known in the art.

During drawing, the evacuated spaces collapse to form silica bridge regions 30, whereas the sealed capillaries 70 and hole 80 increase in their relative size to form air holes 40 and air core 10, respectively.

Alternatively, the capillaries 70 may be evacuated and the spaces between the capillaries sealed, in order that during the drawing step the capillaries collapse to form the silica bridge regions and the spaces between the capillaries remain open to become the air holes.

In the fibre of FIG. 3, there is again a central air-filled core 110, defined by a surrounding annular silica region 120. In the rest of the cross-section of the fibre, two sets of concentric tubular regions can again be distinguished (demarked by dashed lines in the Figure). Firstly, there are annular regions 150, which are of solid silica and correspond to tubes 50 in the fibre of FIG. 1. Secondly, there are annular regions formed by silica bridges 130 that define holes 140. Those parts correspond to bridges 30 and holes 40 in the fibre of FIG. 1, but in the fibre of FIG. 3, the bridges 130 form a significant proportion of the dashed annular regions and contribute to the effective refractive index of those regions. The effective refractive index of the regions containing the holes 140 is thus between 1 and 1.5 (its exact value depends on the shape of the mode guided in the fibre and can be calculated using known mathematical techniques). The fibre thus has a cladding region forming a Bragg stack in radial directions. The refractive index step between the lower-index regions and the higher-index regions is smaller than in the fibre of FIG. 1.

The fibre of FIG. 3 is manufactured in a similar manner, but without the need for sealing or evacuation. A plurality of tubes 160 and capillaries 170 are provided (FIG. 4). A bundle is formed from the tubes 160 and capillaries 170 in which the tubes 160 are arranged concentrically and are separated by concentric rings of capillaries 170. Again, a hole 180 at the centre of the bundle is provided by the inclusion of a silica tube at the centre.

The tubes and capillaries in the bundle are fused to form a preform and the fibre is drawn from the preform on a fibre drawing rig.

The fibre of FIG. 5 does not have circular symmetry in its transverse cross-section; rather, it has hexagonal symmetry.

The higher-index regions 250 are concentric about a core region that is an elongate hole 210. Elongate tubular regions separate the higher-index regions, the tubular regions comprising elongate holes 240 and bridging regions 230. The innermost 220 of those lower-index tubular regions defines the hole 210.

Elongate tubular higher-refractive-index regions 250 contain inter-stitial holes 290, which result from imperfect tiling (because of circular cross-sections) of the canes 270 (FIG. 6) from which the tubular regions 250 were drawn.

The fibre is enclosed in a protective silica jacket 300.

The cladding region in this embodiment (unlike in the embodiments of FIGS. 1 and 2) does not form a simple Bragg stack. We have discovered that structures incorporating air-filled regions and not having circular symmetry may be used to guide light because of the large index difference between lower and higher index regions.

The fibre of FIG. 5 is drawn from the preform of FIG. 6. In this embodiment, the preform consists entirely of silica canes 260 and capillaries 270. The tubular higher-refractive-index regions 250 result from concentric rings of silica canes 260. Elongate holes 240 result from concentric rings of capillaries 270, as in the preforms of FIGS. 2 and 4. Central hole 210 is formed from hole 280, which is defined by the innermost ring of capillaries 270. The fibre of FIG. 5 is drawn from the preform of FIG. 6 in the usual way. Jacket 300 is provided by placing the preform inside a silica tube. Of course, canes such as canes 260 could be used in place of tube 160 in the preform of FIG. 4 (i.e. in a preform having circular symmetry). However, use of canes to form the higher-refractive-index regions is particularly advantageous for fibres not having circular symmetry, because the correct symmetry can easily be realised in the bundle.

The fibre of FIG. 1 may alternatively be made by another method, using the preform bundle of FIG. 7 rather than that of FIG. 2.

The preform of FIG. 7 again comprises large concentric tubes 60, the innermost of which defines hollow core 80. Four concentric tubes 60 are shown in FIG. 7. Capillaries 370, 380 are sandwiched between tubes 60. In contrast to the preform of FIG. 2, in which large gaps existed between adjacent capillaries 70, capillaries 370, 380 are packed tightly into the space between tubes 60.

Capillaries 380 have thicker walls than capillaries 370. Capillaries 380 are arranged in pairs at approximately 60° intervals around each ring defined between tubes 60.

After the bundle is arranged as shown in FIG. 7, it is heated and drawn slightly to fuse together the tubes 60 and capillaries 370, 380. The fused structure is then immersed in an etching agent. For example, the structure may be exposed to a flow of HF for a specified period of time. The etching process removes thinner glass structures, in particular capillaries 370 and much of capillaries 380. However, where each pair of thicker-walled capillaries 380 abut with each other, the resultant double thickness of thicker capillary walls survives the etching process, providing a capillary glass bridge between tubes 60. Arcuate holes are thus defined between the bridges and tubes.

The preform is then overclad with a thick tube and drawn into a fibre similar to that shown in FIG. 1. If desired, during drawing pressure in the core 80 and arcuate holes is adjusted to control the size of the holes.

In an alternative embodiment, pairs of thicker capillaries 80 are displaced azimuthally in successive rings. The resultant bridges are therefore also azimuthally displaced, which avoids a potential problem caused by aligned high-index bridges creating radial directions having significantly higher refractive indices than the refractive index along radial directions that cross successive arcuate holes. A structure of this kind is illustrated in FIG. 8.

The fibre structure illustrated in FIG. 8 is similar to the structure of FIG. 1 in that there are a number of arcuate, low index holes 40, separated by bridges 30, defining each low index layer. However, in contrast to the structure in FIG. 1, the number of arcuate holes 40 increases for each lower-index layer out from a relatively large core 10, in such a way that the size of the holes remains similar in each low index layer. Consequently, not all the bridges in each low index layer are radially aligned. Indeed, the structure in FIG. 8 is arranged so that a minimum number, and preferably none, of the bridges are radially aligned in successive layers.

A perceived advantage of the structure of FIG. 8 is that the arcuate holes 40 in the outer, low index layers have more support, and may be more easily maintained in the required form during the drawing process, than the comparable holes in FIG. 1.

The fibre structure illustrated in FIG. 8 may be made using either of the processes that have been described for making the structure of FIG. 1.

The fibre structure illustrated in FIG. 9 is similar to the structure of FIG. 5, in that it comprises concentric hexagonal lower and higher index regions 250, the inner-most of which 220 defines a relatively large hollow core region 210. According to FIG. 9, holes 240 in each low index layer are substantially rectangular, or more precisely trapezoidal, in their cross section.

The fibre structure in FIG. 9 may be made by forming a pre-form, similar to the pre-form that is used to form the fibre structure of FIG. 1, and arranging the drawing of the fibre such that surface tension in the silica straightens the sides of the structure between bridges, to form the hexagonal shape of the structure. Straightening of the sides of the structure may be achieved by reducing the pressure in the holes during the draw: low enough that surface tension straightens the sides but not so low that the sides of one high index layer collapse into the sides of a neighbouring low index layer. It is expected that this process will of most practical use when the higher index layers are relatively narrow in cross section.

The fibre structure illustrated in FIG. 10 is similar to the structure of FIG. 9, in that the structure has hexagonal symmetry. However, the structure is made using the etching process described above in relation to FIG. 7. In the case of FIG. 10, however, (although not shown) pairs of thicker-walled capillaries are positioned at each corner of each hexagonal, lower-index layer; thinner-walled capillaries are packed in between the thicker-walled capillaries; the structure is heated and fused to form a structure comprising a single body of silica; the structure is etched for a period of time at least sufficient to remove the glass of the thinner-walled capillaries, in order to form a preform; and the resulting preform is heated and drawn into an optical fibre.

The fibre structure illustrated in FIG. 11 is an example of a two-fold rotational symmetry structure, which, in this example, comprises concentric elliptical layers of higher index material 400, separated by bridges 420 to form concentric elliptical lower index regions 440. The inner-most high index layer 460 forms an air core 480 for guiding air in the structure. The lower index regions comprise substantially arcuate holes 440 separated by the bridges 420. By virtue of the two-fold rotational symmetry, the structure exhibits strong birefringence.

The fibre structure in FIG. 11 may be made by either of the methods described for making the structure of FIG. 1, except that elliptical tubes are used instead of circular tubes.

In each of the illustrated embodiments, all of the regions of solid material are fused to form a continuous whole.

1. An optical fibre comprising: (i) a plurality of tubular, higher-refractive-index regions of dielectric material, the higher-index regions being elongate along and concentric about a longitudinal axis; (ii) a plurality of tubular lower-refractive-index regions, arranged between the higher-index regions, the lower-index regions being elongate along the longitudinal axis and comprising bridging regions, of a solid dielectric material, and a plurality of holes, the holes being elongate along the longitudinal axis; and (iii) a core region; wherein the higher-index regions and the lower-index regions together define a cladding structure arranged to guide light in the core region; characterised in that the elongate holes are, in addition to being elongate along the longitudinal axis, elongate in cross-section.

2. A fibre as claimed in claim 1, in which the core region comprises a hole that is elongate along the longitudinal axis of the fibre.

3. A fibre as claimed in claim 1, in which the higher-index regions contain a plurality of holes.

4. A fibre as claimed in claim 1, in which the lower-index regions are arranged to coincide with the zeros of a Bessel function.

5. A fibre as claimed in claim 1, in which the holes in the lower-index regions are large relative to the solid dielectric material in those regions.

6. A fibre as claimed in claim 5, in which the relatively large holes result in the lower-index regions having an effective refractive index that is very close to that of air.

7. A fibre as claimed in claim 1, in which the bridging regions are sufficiently narrow that the effective refractive index of the lower-index regions is significantly lower than the refractive index of the bridging regions.

8. A fibre as claimed in claim 1, in which the bridging regions are sufficiently spaced apart that mode coupling of light between the bridging regions is insignificant in determining the effective refractive index of the lower-index regions.

9. A fibre as claimed in claim 1, in which the holes have in cross-section a generally rectangular form.

10. A fibre as claimed in claim 1, in which the holes have in cross-section a generally trapezoidal form.

11. A fibre as claimed in claim 1, in which the holes have in cross-section a generally arcuate form.

12. A fibre as claimed in claim 1, in which the hole comprised in the core region has a larger cross-sectional area, in the plane perpendicular to the longitudinal axis, than any of the holes in the lower-index regions.

13. A fibre as claimed in claim 1, in which the higher-index regions are tubular regions of circular cross-section.

14. A fibre as claimed in claim 1, in which the higher-index regions are tubular regions of non-circular cross-section.

15. A fibre as claimed in claim 1, in which the bridging regions are narrower than a wavelength of light to be guided in the fibre.

16. A fibre as claimed in claim 1, in which the number of holes in the lower-index regions increases for each consecutive lower-index region out from the core region.

17. A method of making an optical fibre, comprising:
(1) providing a plurality of solid dielectric canes or tubes and dielectric capillaries;
(2) bundling the canes or tubes and capillaries together to form a bundle having a plurality of concentric regions formed of the canes or tubes, such regions being separated from each other by regions comprising the capillaries;
(3) drawing the bundle into an optical fibre, in which the concentric regions formed of the canes or tubes form solid, tubular higher-index regions that are elongate along the longitudinal axis of the fibre, the regions comprising the capillaries form lower-index regions separating the higher-index regions, the lower-index regions being elongate along the longitudinal axis and comprising a plurality of bridging regions and a plurality of holes, the holes being elongate along the longitudinal axis, and a core region is formed, wherein, in the optical fibre, the higher-index regions and the lower-index regions together define a structure arranged to guide light in the core region; characterised in that the elongate holes are, in addition to being elongate along the longitudinal axis, formed to be elongate in cross-section.

18. A method as claimed in claim 17, in which a hole in the bundle forms the core region.

19. A method as claimed in claim 17, in which, in the bundle, the regions comprising the capillaries contain no canes.

20. A method as claimed in claim 17, in which the regions comprising the capillaries contain canes interspersed amongst the capillaries.

21. A method as claimed in claim 17, in which the hole in the bundle that forms the core region is defined by a tube.

22. A method as claimed in claim 21, in which the tube has a central hole that is larger in cross-sectional area than the central hole in the capillaries.

23. A method as claimed in claim 21 in which the tube is a capillary.

24. A method as claimed in claim 17, in which the hole in the bundle that forms the core region is pressurised during the drawing of the fibre.

25. A method as claimed in claim 17, in which the plurality of concentric regions are formed of the canes arranged in rings in the bundle.

26. A method as claimed in claim 17, in which the plurality of concentric regions are formed of the canes arranged in a pattern not having circular symmetry.

27. A method as claimed in claim 17, in which at least some of the capillaries are pressurised during the drawing of the fibre.

28. A method as claimed in claim 17, in which the regions comprising the capillaries comprise a ring of capillaries, of which a plurality have thicker walls than the walls of the other capillaries in the ring, wherein the plurality of bridging regions are formed from the thicker-walled capillaries.

29. A method as claimed in claim 28, in which the thicker-walled capillaries are arranged in pairs and the method comprises the steps of fusing the bundle to form a preform and etching the preform to leave the bridging regions at sites where the capillaries of the pair abutted with each other.

30. A method as claimed in claim 29, in which the pairs of capillaries are arranged in different azimuthal positions in different lower-refractive-index tubular regions.

31. (canceled)

32. (canceled)

33. An optical system, comprising:
an optical fibre including:
(i) a plurality of tubular, higher-refractive-index regions of dielectric material, the higher-index regions being elongate along and concentric about a longitudinal axis;
(ii) a plurality of tubular lower-refractive-index regions, arranged between the higher-index regions, the lower-index regions being elongate along the longitudinal axis and comprising bridging regions, of a solid dielectric material, and a plurality of holes, the holes being elongate along the longitudinal axis; and
(iii) a core region; wherein the higher-index regions and the lower-index regions together define a cladding structure arranged to guide light in the core region; characterised in that the elongate holes are, in addition to being elongate along the longitudinal axis, elongate in cross-section.
